(19) United States
(12) Patent Application Publication
(10) Pub. No.: US 2011/0289935 A1
(43) Pub. Date: Dec. 1, 2011

(54) Thermal Power Plant, in Particular Solar Thermal Power Plant

(76) Inventor: Vladimir Danov, Erlangen (DE)

(21) Appl. No.: 13/138,338

(22) PCT Filed: Jan. 20, 2010
(86) PCT No.: PCT/EP2010/050639

§ 371 Date: Aug. 3, 2011

(30) Foreign Application Priority Data
Feb. 3, 2009 (DE) 10 2009 007 232.2

(51) Int. Cl. F02C 6/00

(52) U.S. Cl. 60/801

(57) ABSTRACT

A thermal power plant, in particular a solar thermal power plant, includes a gas turbine device, in which a medium circulating in a circuit and heated by thermal energy is conducted through a turbine in order to produce electric energy. The medium is subsequently circulated into a condenser cooled by a cooling device in order to liquefy the medium. The cooling device is designed as a solar-operated cooling device having a closed coolant circuit.

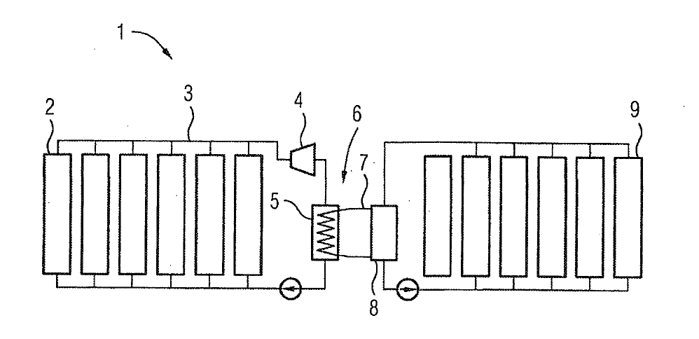

### CROSS REFERENCE TO RELATED APPLICATIONS

This application is based on and hereby claims priority to International Application No. PCT/EP2010/050639 filed on Jan. 20, 2010 and German Application No. 10 2009 007 232.2 filed on Feb. 3, 2009, the contents of which are hereby incorporated by reference.

### BACKGROUND

The invention relates to a thermal power plant, in particular a solar thermal power plant, comprising a gas turbine device, in which a medium circulating in a circuit and heated by thermal energy is conveyed through a turbine in order to produce electrical energy and subsequently into a condenser cooled by a cooling device in order to liquefy the medium.

Power plants, in which thermal energy is converted into electrical energy, are widely known. It is known in such plants to evaporate a medium using the thermal energy, after which the evaporated medium drives a turbine, so generating electrical energy. The vapor is then reliquefied in a condenser cooled by a cooling device and supplied to the evaporator again. It is known in this case in particular to use water cooling to cool the condenser, i.e. to provide a cooling tower filled with water or to draw the water from a natural source in the surrounding environment.

While the use of known heat sources, for example coal, is common, solar thermal power plants are recently gaining attention. They use focused sunlight as a heat source, which then directly or indirectly heats the medium in the evaporator. A wide range of configurations are known for this purpose, for example mirrors arranged in a field reflect sunlight onto a collector tower, which may then be locally heated to very high temperatures. Other options include parabolic mirrors or in particular also so-called parabolic troughs, which focus and collect the sunlight to a point or along a line. It has been proposed, as a replacement for parabolic troughs, to use less costly, flat mirrors, which are arranged in various orientations below the elongate thermal collector.

Although the use of heat accumulators, for example sand, has been proposed for bridging shorter or longer periods without or with reduced sunlight, solar thermal power plants are ideally suited for use in regions which have maximum sunshine hours, for example in deserts or the like. However, a distinguishing feature of these regions is in particular that natural water resources are extremely rare and losses of water by evaporation would be virtually unjustifiable. While it is possible to use an air-cooled condenser instead of a water-cooled condenser, this has the disadvantage of a much poorer cooling action, so entailing a significant reduction in power plant efficiency.

### SUMMARY

One possible object is therefore to conFIGURE a power plant in such a way that no natural water resources are needed or no water losses occur.

The inventor proposes for the cooling device to take the form of a solar-driven cooling device with a closed coolant circuit.

A completely new power plant design is described herein, which may advantageously be used in particular in regions with high levels of solar radiation, since a cooling device operated with input of energy is used, but with the sun as the energy source. In this way it is possible without major effort to produce a power plant in which a coolant circuit may be provided, for example a water circuit or an oil circuit. The coolant, which may as mentioned be water or oil, is here constantly circulated and is not lost. The water is itself cooled by a solar-driven cooling device, heat from solar radiation being converted into cold.

The power plant is in this case particularly advantageously a solar thermal power plant, which is in any event used in regions with long sunshine hours.

While it is in principle conceivable to make indirect use of solar heat to drive the cooling device, a particularly convenient configuration of the inventor's proposal may provide for solar heat recovered from solar radiation in the solar-driven cooling device to be used to drive a refrigerator. Refrigerators are known in principle. They implement a thermodynamic cycle, in which heat is taken up at below ambient temperature and output at a higher temperature. By such a refrigerator the solar heat may thus be converted directly into cold for cooling the condenser by the cooling device. The cooling device may in this case be a thermoacoustic refrigerator or a Stirling refrigerator, in particular a plurality of Stirling refrigerators, or an absorption refrigerator, in particular a diffusion absorption refrigerator, the absorption refrigerator being preferred.

The principle of the thermoacoustic refrigerator is a relatively new development, in which the acoustic energy of a standing sound wave in a suitable resonator is used for heat transfer. Heat or cold is here transferred by way of the periodic pressure oscillations undergone by a packet of gas in a standing longitudinal sound wave. The sound wave may in this case for example be generated electromechanically by way of a loudspeaker, pumping heat against a temperature gradient along a medium with storage capacity, the “stack”. A temperature gradient builds up along the stack. The resultant heat or cold may be coupled out on both sides of the stack using heat exchangers. Such a thermoacoustic refrigerator is advantageous in particular since the sole moved part thereof is the sound wave generator.

A further variant of a refrigerator which may be used is the Stirling refrigerator. Such machines are widely known and are based on the Stirling process. However, to achieve the required refrigeration capacity, it may be necessary to use a plurality of Stirling refrigerators as the cooling device.

An absorption refrigerator is, however, preferably used. In such a refrigerator, unlike in a compression refrigerator, compression is effected by exposing a solution of the refrigerant in a solvent to thermal influence. This arrangement is also known as a “thermal compressor”. An absorption refrigerator also has a solvent circuit. The two components, solvent and refrigerant, are often also described jointly as working fluid. It is important for the refrigerant to be completely soluble in the solvent. Combinations which are often used are water as refrigerant and lithium bromide as solvent or indeed ammonia as refrigerant and water as solvent. In the circuit, the working fluid is firstly separated into its constituents in an “expeller”, by heating the solution. The refrigerant evaporates due to its lower evaporation temperature, after which the solvent residues co-evaporated with the refrigerant are removed from the refrigerant vapor by a fluid separator. In a condenser the refrigerant is liquefied, in order to be evaporated in the evaporator with absorption of ambient heat, so resulting in the useful effect. The refrigerant vapor is then conveyed into the absorber, in which a solution is once again obtained. The solvent is introduced into the solution after separation from the refrigerant, once it has been decompressed to the absorber pressure and cooled by a valve. It is the solvent circuit which is ultimately described as the “thermal compressor”, since it takes on the corresponding tasks of the compressor of the compression refrigerator.

A variant of the absorption refrigerator is the so-called diffusion absorption refrigerator, in which pressure change takes place as a partial pressure change, however, so dispensing with the last mechanically moved component in the form of the solvent pump. However, the working fluid needs a third component, namely an inert gas. Diffusion absorption refrigerators thus merely require input of solar heat.

The cooling device may then be driven directly by the solar heat or by a heat transfer oil which transfers the solar heat. These are the two fundamentally known methods also used in solar thermal power plants. The solar heat may be used immediately or firstly conveyed to the place of use by a heat transfer oil.

Particularly advantageously, in a solar thermal power plant with solar collectors heat from at least some of the solar collectors may be used to drive the cooling device. In any event once solar collectors have been provided in a solar thermal power plant, some of these solar collectors may be used to drive the cooling device. In comparison to today's solar thermal power plants, it is in this case simply possible to provide a plurality of additional solar collectors, which are assigned to the cooling device.

### BRIEF DESCRIPTION OF THE DRAWINGS

These and other objects and advantages of the present invention will become more apparent and more readily appreciated from the following description of the preferred embodiments, taken in conjunction with the accompanying drawing of which:

The single FIGURE shows a schematic diagram of a solar thermal power plant according to the inventor's proposal.

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

The FIGURE shows an exemplary embodiment of a solar thermal power plant 1 according to the proposal. It comprises first solar collectors 2 serving to drive the power plant, which in this case take the form of parabolic troughs. By way of the solar heat thus centered in a central zone by the parabolic troughs, a medium circulating in a circuit 3 is directly heated and evaporated, the resultant vapor being converted into electricity in a turbine 4. In a condenser 5 the medium is reliquefied, the condenser being cooled by a solar-driven cooling device 6. The medium liquefied in this way is then evaporated again, so completing the circuit 3. It should be noted at this point that the FIGURE is clearly only a schematic diagram of the most important components; the principle of a thermal power plant is widely known and need not be described in detail here.

As an alternative to direct heating of the medium by solar heat, it is moreover also possible to convey the solar heat to an evaporator via a heat transfer oil.

The cooling device 6 comprises a closed coolant circuit 7, in which water circulates as coolant. The water is cooled to the necessary temperatures by the refrigerator 8, which here takes the form of an absorption refrigerator, more specifically a diffusion absorption refrigerator. The heat required for this purpose is again solar heat, which is captured by solar collectors 9. The precise operation of the refrigerator 8 is generally known and need not be described in detail here.

It should however also be noted that the refrigerator 8 may also be a Stirling refrigerator or a thermoacoustic refrigerator. In addition, the heat from the solar collectors 9 may be used directly as the heat source for the refrigerator 8 or indeed transferred thereto by a heat transfer oil.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-6. (canceled)

7. A solar thermal power plant, comprising:
a gas turbine device, in which a medium circulating in a circuit and heated by thermal energy is conveyed through a turbine in order to produce electrical energy, the medium being conveyed into a condenser after the turbine; and
a cooling device to cool the condenser in order to liquefy the medium, the cooling device being a solar-driven cooling device with a closed coolant circuit.

8. The power plant as claimed in claim 7, wherein water or oil is circulated in the closed coolant circuit as a coolant.

9. The power plant as claimed in claim 7, wherein
the solar-driven cooling device recovers solar heat from solar radiation, and
the solar-driven cooling device has a refrigerator driven by the solar heat.

10. The power plant as claimed in claim 9, wherein the refrigerator is selected from the group consisting of a thermoacoustic refrigerator, a Stirling refrigerator and an absorption refrigerator.

11. The power plant as claimed in claim 9, wherein the refrigerator is a plurality of Stirling refrigerators.

12. The power plant as claimed in claim 9, wherein the refrigerator is a diffusion absorption refrigerator.

13. The power plant as claimed in claim 9, wherein the refrigerator of the cooling device is driven directly by the solar heat or is driven indirectly by the solar heat using a heat transfer oil that transfers the solar heat.

14. The power plant as claimed in claim 7, wherein
solar collectors provide thermal heat to heat the medium, and
heat from at least some of the solar collectors is used to drive the cooling device.

15. The power plant as claimed in claim 8, wherein
the solar-driven cooling device recovers solar heat from solar radiation, and
the solar-driven cooling device has a refrigerator driven by the solar heat.

16. The power plant as claimed in claim 15, wherein the refrigerator is selected from the group consisting of a thermoacoustic refrigerator, a Stirling refrigerator and an absorption refrigerator.

17. The power plant as claimed in claim 16, wherein the refrigerator of the cooling device is driven directly by the solar heat or is driven indirectly by the solar heat using a heat transfer oil that transfers the solar heat.

18. The power plant as claimed in claim 17, wherein
solar collectors provide thermal heat to heat the medium, and
heat from at least some of the solar collectors is used to drive the cooling device.
